(19) United States
(12) Patent Application Publication
(10) Pub. No.: US 2001/0025859 A1
(43) Pub. Date: Oct. 4, 2001

(54) Mixing and dispensing container having removably attachable supply vessels

(76) Inventor: Charles Dumont, Miami, FL (US)

Correspondence Address: Terrance L Siemens, P O Box 2832, Fairfax, VA, 22031, US

(21) Appl. No.: 09/505,668

(22) Filed: Feb. 17, 2000

(51) Int. Cl. B67D 5/52

(52) U.S. Cl. 222/136; 222/145.6; 222/235; 222/325

(57) ABSTRACT

A dispensing container which stores two or more separated fluids and blends the fluids when dispensing. The container has two or more liquid receptacles and a cap which threads to the bottle. The receptacles include the open interior of the container, and an interior vessel separate and removable from the container. The cap is connected a mixing circuit which retrieves and blends fluids taken from the receptacles. A pump, which may be either manually or electrically operated, draws fluids from the receptacles and discharges these fluids after they are mixed. The dispensing container has at least one, and optionally a plurality of separate, attachable auxiliary vessels. The auxiliary vessels communicate with the mixing circuit or alternatively with one another. The auxiliary vessels are constructed to hold pressurized propellant, while the dispensing container is formed from plastic. Internal circuitry has check valves which relieve vacuum which would otherwise develop within the container, and includes valves which open responsive to auxiliary vessels being installed or inserted into the dispensing container.

### REFERENCE TO RELATED APPLICATION

This application is related to my co-pending application Ser. No. 09/412,581, filed Oct. 5, 1999, and Provisional Patent Application Ser. Nos. ______, filed November, 1999, and No. ______, filed January, 2000.

### BACKGROUND OF THE INVENTION

1. Field of the Invention

The present invention relates to containers which blend fluent materials stored in separate chambers when dispensing these materials. More particularly, the invention sets forth a container which cooperates with a removable vessel which communicates with the container for the purpose of introducing a separate fluid thereto. The container has a dispensing pump for discharging fluids stored within the container. The novel dispensing container finds application wherever fluid materials must be blended and dispensed in quantities appropriate for individual consumers. For example, the container may be utilized by consumers to store and dispense personal care products such as shampoo and hair conditioner, products such as oil and vinegar for preparing salad dressings, among others. Alternatively, the container may be utilized in industrial, commercial, institutional, medical, and scientific applications to blend active ingredients with carrier fluids, or to blend ingredients which would interact on contact with one another. The fields which may benefit from the invention are many and diverse.

2. Description of the Prior Art

It is necessary from time to time to dispense several dissimilar fluent substances which must be separated from one another prior to being utilized, yet blended when utilized. In many cases, the precise proportions of the two substances cannot be determined until the last minute. If the two substances were separately stored, it would require extreme care to assure that they be accurately mixed together. Also, metering and dispensing of two separate substances is somewhat time consuming. Furthermore, separate metering and dispensing may expose one or both substances to contact with the air, airborne contaminants, light, or other detrimental influences.

Another aspect of containers is that in many cases, it is not feasible to provide separate fluids in proportional ratios. That is, it is frequently the case that one fluid is depleted while a usable quantity of another fluid yet remains. The fluid may be among the contents being dispensed, or alternatively may be a carrier fluid or a propellant. To this end, it would be desirable to provide a container which accommodates connection of a separate vessel containing one of the fluids.

This feature is shown in U.S. Pat. No. 5,908,107, issued to Baudin et al. on Jun. 1, 1999, wherein one vessel threads to another. However, the device of Baudin et al. lacks the mixing and dispensing pump of the present invention, and also lacks alignable ports or valves which enable immediate communication between the two receptacles when the detachable vessel is connected to the principal container.

It is convenient and effective to store, meter, blend, and dispense several substances from a single container in a manner assuring that plural contents be separated until the point in time at which they are used. The prior art has proposed containers which dispense plural contents. An example is seen in U.S. Pat. No. 3,850,346, issued to James E. Richardson et al. on Nov. 26, 1974. The subject dispenser of Richardson et al. is hand squeezed to dispense fluids, whereas the present invention includes a pump. Also, the present invention has an internal circuit cooperating with a removable vessel.

U.S. Pat. No. 5,439,137, issued to Jean-Francois Grollier et al. on Aug. 8, 1995, shows an aerosol type dispenser having plural fluid containers which dispense fluid. Unlike the present invention, there is no manual pump and no separable, connectable vessel.

U.S. Pat. No. 5,127,548, issued to Michel Brunet et al. on Jul. 7, 1992, features a dispenser having a plunger pump at one end and a discharge nozzle at the other end, in the manner of a hypodermic syringe. Actuation of the plunger ruptures a barrier which separates two stored fluids. The present invention lacks a frangible barrier which would require renewing for each subsequent use. Also, there is no mixing circuit incorporating check valves, as seen in the present invention, and no separable, connectable vessel. In the present invention, fluid is discharged through the pump, whereas this arrangement is not possible in the device of Brunet et al.

U.S. Pat. No. 5,588,550, issued to Robert C. Meyer on Dec. 31, 1996, illustrates a compartmented container which dispenses plural fluids in adjustable proportion. However, Meyer lacks a plunger pump and a dispensing circuit having check valves and an internal mixing chamber, as seen in the present invention, as well as a separable, connectable vessel.

U.S. Pat. No. 5,890,624, issued to William M. Klima et al. on Apr. 6, 1999, shows a dispensing container providing plural storage compartments and an indirectly operated plunger pump. Klima et al. has a dispensing circuit incorporating check valves and a mixing chamber. However, Klima et al. lacks a separable, connectable vessel, an agitator or mixing structure carried on the piston of the pump, and an internal support for supporting one of the storage compartments within the container. By contrast, these features are all seen in the present invention. Klima et al. has a plunger type pump. However, this pump is indirectly actuated by a trigger and associated linkage, whereas the pump of the present invention is directly actuated.

None of the above inventions and patents, taken either singly or in combination, is seen to describe the instant invention as claimed.

### SUMMARY OF THE INVENTION

The present invention affords a hand held, pump action dispensing container or dispenser which is suitable for enabling consumers to blend and dispense many different fluids. The novel container has a storage receptacle in the form of a jar or bottle open at one end, and threads for securing a cap which bears a discharge nozzle. Optionally, the storage receptacle is divided into several compartments each intended to contain one fluid. The compartments are, in different embodiments, arranged side by side, one above the other, or one within another. Fluids contained within the compartments may be mixed in any desired proportion prior to discharge. The fluids are mixed or blended internally within the container prior to discharge.

The novel container has an associated separate auxiliary vessel which is connectable thereto. The separate vessel contains a second fluid which may interact with the first fluid contained within the container, or which may be a carrier fluid, a propellant, such as pressurized gas, or which may serve some other purpose. The container has passages which are opened by installing the separate vessel in the container. These passages establish communication between a compartment of the dispenser and the separate vessel. Communication occurs only when the separate vessel is installed in the container of the dispenser. Selectively opened passages enable residual pressure, in containers operated by pressurized propellant, to be vented relieved prior to opening the container, and without unduly depleting the source of propellant. Withdrawal of the vessel closes passages such that no undesired leakage to the outside of the container occurs.

A principal application of the invention is to provide pressurized propellant gas in a small, inexpensive vessel so that the principal container can be economically fabricated from an inexpensive material such as plastic. The pressure vessel can be fabricated from aluminum, steel, or any other suitable material.

The pressure vessel is removable from the principal container. This leads to certain advantages apart from cost of the container and attachable vessel. For example, depletion of one of the fluids need not cause the container and any remaining quantity of the other fluid to be discarded. Both fluids can be renewed as desired. Therefore, mismatches in quantity between propellant and the fluid being dispensed can be overcome. Both the fluid being dispensed and the propellant can independently, and at any time, be renewed as required. This feature enables usage of the container to continue with minimal regard for depletion of either propellant or of the fluid being dispensed.

A dispensing circuit enclosed within the container has a pick up tube for each compartment of the container, a common mixing chamber, and check valves to prevent cross contamination of storage compartments by backflow within the mixing circuit and to isolate the mixing chamber from exposure to the outside atmosphere.

The dispensing circuit and its conduits are secured to the cap. One of several types of pumps are incorporated to achieve forced dispensing. A manual plunger type pump is one possible type of pump. The plunger pump operates by direct action, that is, its upper portion is contacted by the user's hand and depressed. Depressing the plunger directly pressurizes fluid contained in the mixing chamber. Pressurized fluid can escape only through the discharge nozzle. A spring returns the plunger to its original position where it is ready for the next pressurizing stroke. The return stroke generates a partial vacuum in the mixing chamber which recharges the mixing chamber with fluids retrieved from storage. An optional proportioning valve adjusts proportions of fluids retrieved from storage. An electrically operated pump is an alternative to a manual pump.

Optionally, paddles or vanes are carried on the pump to improve blending within the mixing chamber. This option is used when highly viscous fluids are to be mixed, or when dispensing any fluids which resist spontaneous mixing. In a further option, a support cage or frame for supporting a small storage container within the bottle or jar depends from the cap.

A significant advantage of the invention is that preexisting spray heads can be utilized. This is of interest to manufacturers who will be able to utilize existing tooling to fabricate the spray head.

Another advantage of the invention is that the container, together with its internal circuits and valve features, can be manufactured by known molding techniques in a homogeneous single part, or in relatively few mutually attachable parts. Materials utilized to fabricate the container are readily recyclable.

Accordingly, it is an object of the invention to provide a hand held dispenser which blends and dispenses plural fluids which must be stored separated from one another.

Another object of the invention is to provide a hand held fluid dispenser which has a removably attachable auxiliary vessel, and which dispenser receives fluid from the auxiliary vessel.

It is another object of the invention that the dispenser and auxiliary vessel establish paths of communication therebetween to enable the various fluids to contact one another, and to close these paths of communication to prevent undesired discharge of the contents of the dispenser.

It is a further object of the invention to provide a mixing chamber for mixing fluids, which mixing chamber is isolated from the outside atmosphere.

Yet another object of the invention is to provide apparatus enabling standard pump spray dispensers to be readily converted from single fluid operation to blending and dispensing operation.

Still another object of the invention is to vary proportions of fluids being mixed and dispensed.

An additional object of the invention is that the dispenser be manufactured by molding techniques, and that discarded dispensers be readily recyclable.

Still another object of the invention is to enable pressurized dispensing containers formerly fabricated from steel to be fabricated from inexpensive materials, with only the vessel containing pressurized propellant to be fabricated from metals and their alloys.

It is a further object of the invention to vent residual pressure in propellant operated dispensing containers when dispensing is finished, without depleting the source of pressurized propellant.

Yet another object of the invention is to provide direct; actuation of the pressurizing plunger, and to discharge pressurized fluids through the cap.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a partially exploded, cross sectional, side elevational view of a dispensing container which may incorporate the present invention.

FIG. 2 is a cross sectional, side elevational view of a second embodiment of a dispensing container which may incorporate the present invention.

FIG. 3 is a top plan detail view of the upper center of FIG. 1.

FIG. 4 is a top plant detail view of the upper center of FIG. 1, showing an adjustment from the positions shown in FIG. 3, made by mutually rotating the components relative to one another.

FIG. 5 is a top plan view of a dispensing container which may incorporate the present invention.

FIG. 6 is a side elevational, cross sectional view of an alternative embodiment of a dispensing container which may incorporate the present invention.

FIG. 7A is a side elevational, cross sectional view of an embodiment of the invention incorporating a removable auxiliary fluid containing vessel.

FIG. 7B is a diagrammatic, side elevational detail view of an embodiment of the invention, showing closure of fluid circuits when an auxiliary fluid vessel is removed from the host container.

FIG. 7C corresponds to FIG. 7B, but shows the auxiliary fluid vessel installed in the host container.

FIG. 8 is a side elevational, cross sectional view of a second embodiment of the invention, incorporating a removable auxiliary fluid containing vessel.

FIG. 9 is a side elevational, cross sectional view of an embodiment of the invention incorporating an electrically operated pump.

FIG. 10A is an enlarged, side elevational detail view, shown mostly in cross section, of an auxiliary fluid vessel.

FIG. 10B is similar to FIG. 9A, but shows an internal sliding valve projecting from the auxiliary vessel.

FIG. 11 is a perspective detail view, partially broken away to reveal internal detail, of an auxiliary vessel similar to that of FIG. 11A, but modified to discharge fluid from a bottom surface.

FIG. 12 is a side elevational, cross sectional view of an embodiment of the invention showing a plurality of auxiliary vessels associated with one dispensing container.

FIG. 13 is a side elevational view of another embodiment of the invention depicting plural auxiliary vessels.

FIG. 14 is a side elevational view of a component which attaches additional auxiliary vessels to those of FIG. 13.

FIG. 15 is a side elevational view, shown mostly in cross section, of an embodiment featuring an interlock which discharges pressurized propellant into the novel container only during dispensing of the contents of the container.

### DETAILED DESCRIPTION OF THE PREFERRED EMBODIMENTS

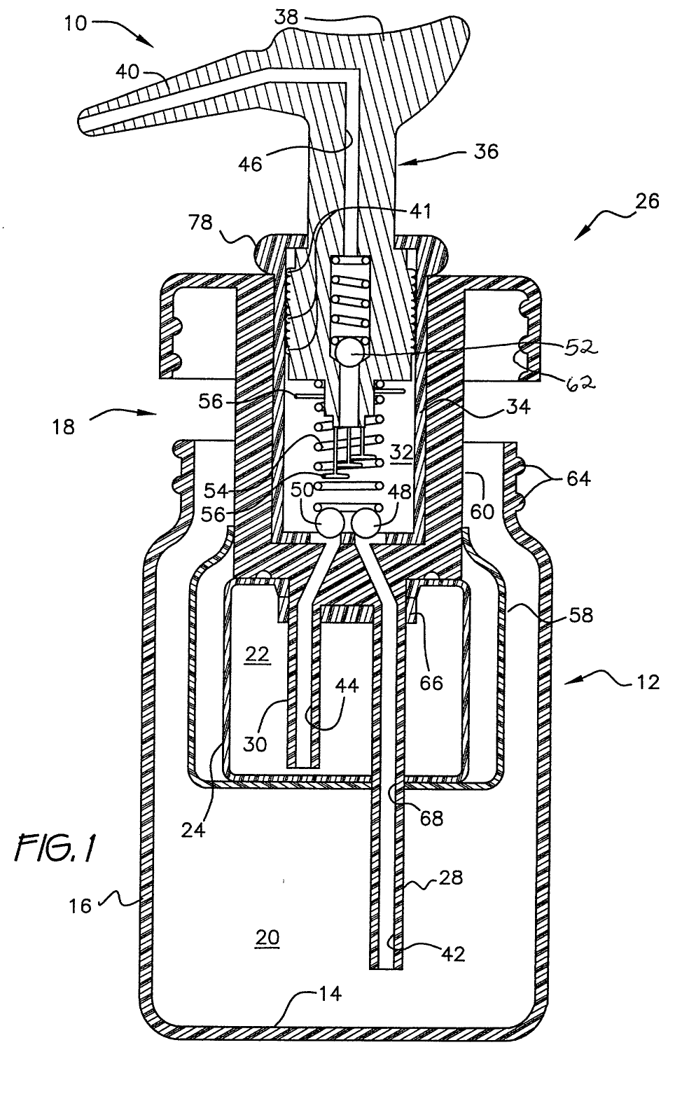

The present invention improves upon the container shown in my co-pending application Ser. No. 09/412,581, filed Oct. 5, 1999, which is incorporated therein by reference. Reviewing the subject matter of the co-pending application, and as shown in FIG. 1 of the drawings, novel dispensing container 10 is seen to comprise a storage bottle 12 having a floor 14, a lateral wall 16, and an open upper end 18. A receptacle 20 for storing a fluid for subsequent dispensing is defined within bottle 12. Container 10 stores two fluids separately, and can blend these fluids immediately prior to dispensing. A second receptacle 22 is defined within storage vessel 24. Storage vessel 24 is dimensioned and configured to be insertable into, contained within, and readily retrieved from receptacle 20.

A cap 26 closingly engages upper end 18 of storage bottle 12. Components of a mixing and dispensing circuit and a pump for pressurizing fluids being dispensed are carried on cap 26. The mixing and dispensing circuit includes a first pick up tube 28 extending from cap 26 into receptacle 20, terminating near floor 14. A second pick up tube 30 depends from cap 26, extending to near the bottom of receptacle 22 of storage vessel 24. Pick up tubes 28, 30 discharge their respective retrieved fluids into a mixing chamber 32.

Mixing chamber 32 is defined within a generally cylindrical member 34. A pump is provided by a plunger 36 which is slidably disposed within cylindrical member 34 and accessible to manual contact from above cap 26. The pump pressurizes and propels fluids contained within mixing chamber 32. Plunger 36 includes a head 38 formed to define structure which cooperates with a user's thumb or finger, and a discharge nozzle 40 opening to the outside atmosphere. Circumferential ribs 41 project outwardly from plunger 36 at that portion contacting the interior surface of member 34, for improving engagement of an external object. Illustratively, it is easy to grasp plunger 36 manually when assembling container 10 when ribs 41 engage the fingertips. The function of member 34 will be described hereinafter.

The dispensing circuit includes a first conduit 42 formed in pick up tube 28, a second conduit 44 formed in pick up tube 30, mixing chamber 32, and a discharge conduit 46 formed in head 38 of plunger 36. Discharge conduit 46 is disposed to conduct pressurized fluid from the pump to discharge nozzle 46. Conduits 42, 44, and 46 are disposed in fluid communication with chamber 32, subject to respective check valves 48, 50, 52. Check valves 48, 50 prevent back flow of blended fluids from chamber 32 into their respective receptacles 20, 22, to preclude cross contamination of stored fluids. Check valve 52 closes chamber 32 to fluid communication with the outside atmosphere, thereby minimizing possible deterioration of mixed fluids due to contact with air and airborne contaminants.

When plunger 36 is depressed by the user from the ready position shown in FIG. 1, plunger 36 imposes pressure on fluids contained within chamber 32. These fluids can escape only through conduit 46, and are subsequently discharged through nozzle 46. A return spring 54 urges plunger 36 upwardly towards the ready position, thereby generating a partial vacuum within chamber 32. This vacuum draws fluids from receptacles 20, 22 past check valves 48, 50 into chamber 32.

Plunger 36 performs the further function of actively mixing or blending fluids drawn into chamber 32. Mixing vanes or blades 56 project downwardly from plunger 36 such that they have a tendency to stir and mix fluids in chamber 32.

A support cage or frame 58 is attached to that portion 60 of cap 26 projecting into receptacle 20 of bottle 12. Support frame 58 surrounds vessel 24 and retains vessel 24 against portion 60 of cap 26.

In the embodiment of FIG. 1, vessel 24 is contained within receptacle 20 of bottle 12, and is removed therefrom by withdrawing cap 26. Cap 26 has threads 62 which engagingly mate with threads 64 formed in bottle 12. Pick up tube 28 passes through an upper opening 66 and a lower opening 68 formed in vessel 24 so that pick up tube 28 has access to fluid stored below vessel 24 in receptacle 20. Vessel 24 and pick up tubes 28, 30 are withdrawn from bottle 12 when cap 26 is unthreaded and removed.

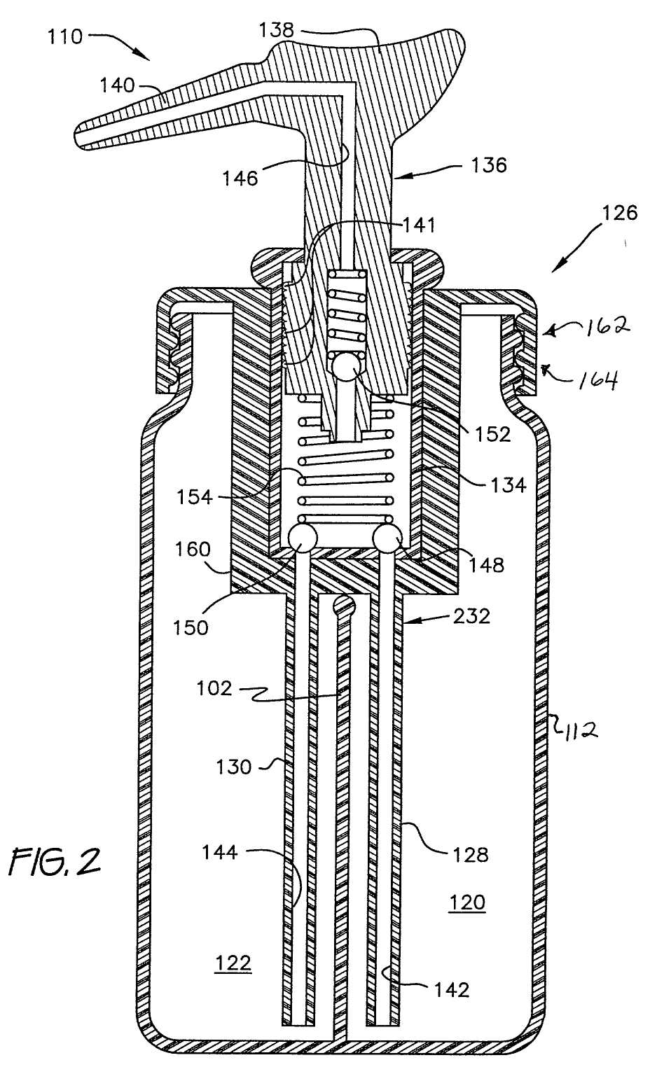

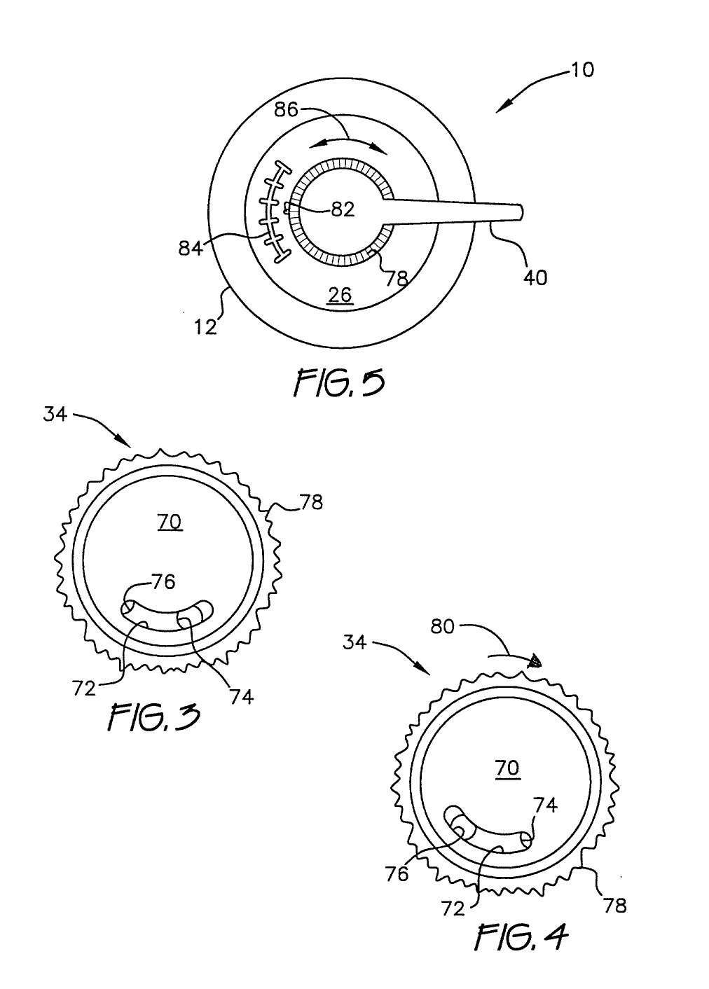

Referring now to FIG. 2, in another embodiment of the invention, container 110 has two fluid storage receptacles 120, 122 formed in bottle 112. Receptacles 120, 122 are separated from one another by an interior partition wall 102. Bottle 112 is closed by cap 126. Pitch of threads 162, 164 is modified from the embodiment of FIG. 1 so that cap 126 is fully installed prior to interference occurring between pick up tubes 128, 130 with wall 102. Wall 102 and the bottom portion 160 of plunger 136 are dimensioned and configured so that lower portion 160 of plunger 136 contacts wall 102, thereby sealing and separating receptacles 120, 122.

Cap 126 carries a member 134 and a plunger 136, which are both essentially similar to member 34 and plunger 36 of FIG. 1. The only difference between the embodiments of FIG. 1 and FIG. 2 is that receptacles 120, 122 in FIG. 2 are both formed integrally with bottle 112. Optional mixing blades 41 are omitted from the embodiment of FIG. 2. The embodiment of FIG. 2 is appropriate where the proportions of the two fluids approach equality in the blended mix.

Both embodiments incorporate an adjustable proportioning valve disposed to selectively vary proportions of fluids entering the mixing chamber. This feature will be described in terms of the embodiment of FIG. 1, although it will be understood that the operative principles are equally applicable to the embodiment of FIG. 2. Turning now to FIG. 3, floor 70 of member 34 is seen to have an arcuate opening 72 which exposes upper opening 74 of conduit 42 (see FIG. 1) and upper opening 76 of conduit 44 (see FIG. 1) to fluid communication with chamber 32. Member 34 may be grasped by a knurled, ridged, or otherwise textured collar or flange 78 (see also FIG. 1) and rotated to vary the cross sectional exposed area of openings 74, 76. Member 34 is rotatably contained within section 60 of plunger 26 so that this adjustment is possible.

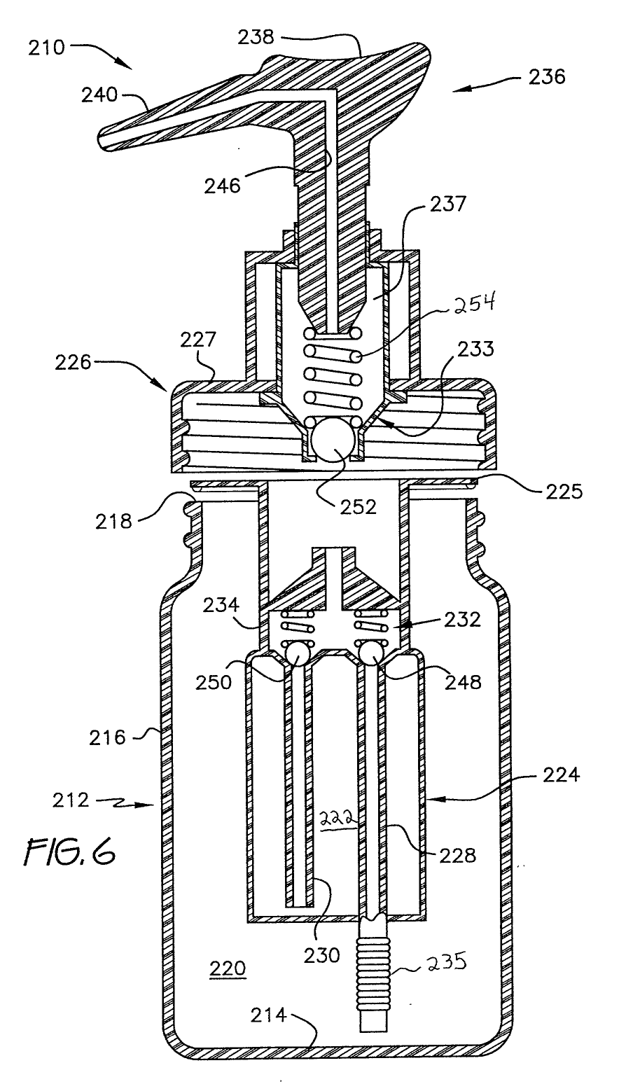

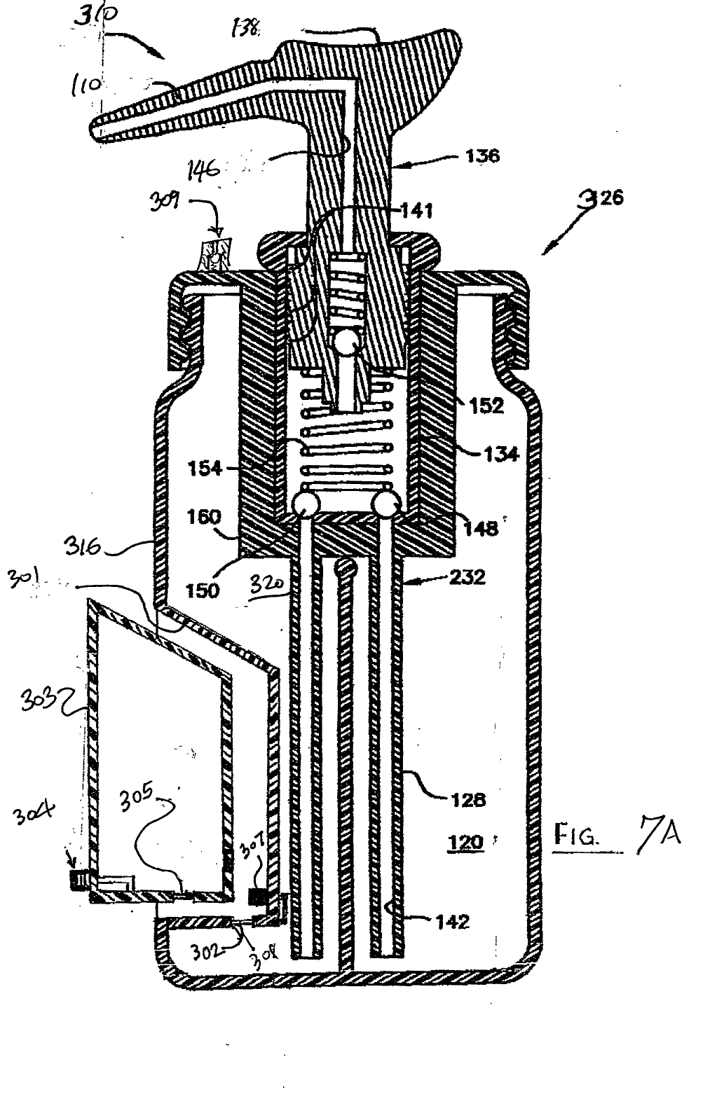

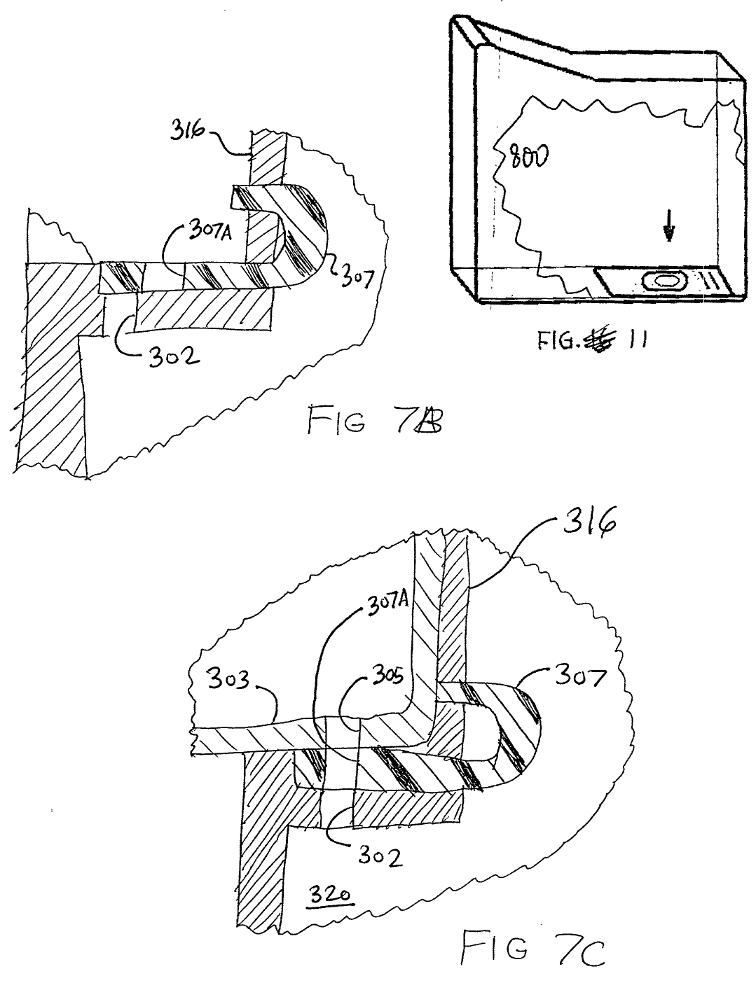

FIG. 4 shows adjustment which has been made from the relative positions of member 34 and the bottom of portion 60 of cap 26 originally shown in FIG. 3. In FIG. 3, opening 74 is fully uncovered, and opening 76 is partially obstructed by floor 70 of member 34. In FIG. 4, member 34 has been rotated in the direction of arrow 80 with the result that opening 74 is now partially obstructed and opening 76 is fully open. The proportions of respective fluids which will be drawn into chamber 32 by suction on the return stroke of plunger 36 will vary accordingly. Proportions of fluids entering chamber 32 are therefore infinitely adjustable within the range enabled by the cross sectional area of conduits 42, 44 and opening 72.

FIG. 5 shows the externally visible components of container 10, as they relate to adjustment of proportion of the fluid mix. A pointer 82 formed in flange 78 is arranged to align with index marks of an index scale 84 molded into or printed on cap 26. Rotation of member 34 in directions indicated by arrow 86 by grasping flange 78 will be reflected by different relative positions of pointer 82 and scale 84.

FIG. 6 shows an embodiment particularly adapted for modification of pre-existing spray dispensers not originally designed to incorporate blending features. Container 210 includes a storage bottle 212 having a floor 214, a lateral wall 216, and an upper edge 218. A receptacle 220 for storing a fluid for subsequent dispensing is defined within bottle 212. A second receptacle 222 is defined within storage vessel 224. Storage vessel 224 is dimensioned and configured to be insertable into, contained within, and readily retrieved from receptacle 220.

The embodiment of FIG. 6 departs from that of FIG. 1 in that vessel 224 is configured to be supported from upper edge 218. To this end, vessel 224 has a flange 225 which will come to rest on upper edge 218 when vessel 224 is inserted into receptacle 220 of bottle 212. Cap 226 has a horizontal member 227 which entraps flange 225 when cap 226 is threaded to bottle 212.

The spray pump of the embodiment of FIG. 6 operates similarly to that of FIG. 1, but is adapted to be compatible with vessel 224. A mixing chamber 232 is formed within a housing 234 formed at the top of vessel 224. A first pick up tube 228 depends from member 234 and passes through vessel 224. A telescopic tubular extension 235 extends nearly to the floor 214 of bottle 212. Fluid drawn by suction from the pump will enter extension 235, pass through pick up tube 228, and pass by check valve 248 to enter mixing chamber 232. A second pick up tube 230 depends from member 234 and extends nearly to the bottom of vessel 224. Fluid drawn by suction from vessel 224 is conducted through tube 230 past check valve 250 to enter mixing chamber 232.

The pump of container 210 includes a plunger 236 slidably disposed on cap 226 and a head 238 which is the equivalent of that of the embodiment of FIG. 1. A housing 233 acts in concert with cap 236 to form a suction chamber 237 which is in fluid communication with mixing chamber 232. A check valve 252 carried in housing 233 separates mixing chamber 232 from suction chamber 237. Preferably, check valves 248, 250, and 252 each have a spring urging the respective valve into the closed position. These springs are sufficiently weak so that their associated valves will open responsive to suction established when plunger 236 moves upwardly responsive to return spring 254 after the user has removed manual pressure from plunger 236. Container 210 has a dispensing circuit including the conduit provided by pick up tubes 228, 230, mixing chamber 232, suction chamber 233, and a discharge conduit 246 formed in head 238. The overall function of the dispensing circuit of container 210 is similar to that of container 10 as regards pumping action, check valve operation, retrieval of fluids from receptacles 220, 222, and dispensing of blended fluids under pressure from the pump. The pump utilizes plunger 236 in a manner similar to that of plunger 36 of container 10. In container 210, blending may occur in chamber 237 as well as in chamber 232. The significant advantage of container 210 is that insertion of vessel 224 into bottle 212 readily converts a standard pump dispensing container (not shown) into a blending dispensing container. Most of head 238 and plunger 236 can be adapted for use in container 210, this requiring-a limited degree of truncation of the original suction chamber and downwardly depending portion thereof from the original head and plunger (not shown).

Progressive depletion of fluids stored in the various receptacles of all embodiments may be accommodated in any suitable way. Air relief valves (not shown) may be incorporated where desired. A source of compressed gas may be provided to prevent collapse or inoperability upon depletion of stored fluids. Alternatively, one or more receptacles may be flexible, so that they collapse in controlled fashion as their contents are removed.

FIG. 7 shows a modification of the embodiment of the embodiment of FIG. 2. The embodiment of FIG. 7 shares many structural features with that of FIG. 2, and reference numerals common to both Figures indicate structurally identical features. These features are described prior, and therefore description need not be repeated with respect to FIG. 7. In the embodiment of FIG. 7, lateral wall 316 of container 310 has a recess 301 for receiving a separate auxiliary vessel 303. An opening 302 admits fluids from vessel 303 into compartment 320 of container 310. An externally operable valve 304 opens opening 305 formed in the floor of auxiliary vessel 303. Fluids from compartment 320 are drawn into the mixing and dispensing circuit by the pump associated with plunger 136. A laterally displaceable link 307 controls a valve 308 to open opening 302 when vessel 303 is inserted into recess 301. A unidirectional check valve 309 is disposed within cap 326 to admit air into compartment 320 from the exterior thereof. This feature relieves vacuum which would otherwise be generated by operation of the pump. Other check valves (not shown) may be provided at other locations on dispensing container 310 to relieve vacuum which would otherwise interfere with operability.

FIGS. 7B and 7C illustrate how link 307 operates. Link 307 is disposed within lateral wall 316 of container 310 (see FIG. 7A). Link 307 has an opening 307A and a section 307B which projects to the left of wall 316, into recess 301. It will be seen by examining FIG. 7B that opening 302 is misaligned with opening 307A. As a consequence, no communication is established between compartment 320 of container 310 and the exterior thereof.

After auxiliary vessel 303 is fully inserted or installed in container 310, occupying recess 301, it displaces link 307 by moving link 307 to the right, as depicted in FIG. 7C. This causes openings 302, 305, and 307A to align, thereby establishing fluid communication between vessel 303 and compartment 320. Although not shown, link 307 is preferably spring biased into the closed position of FIG. 7B.

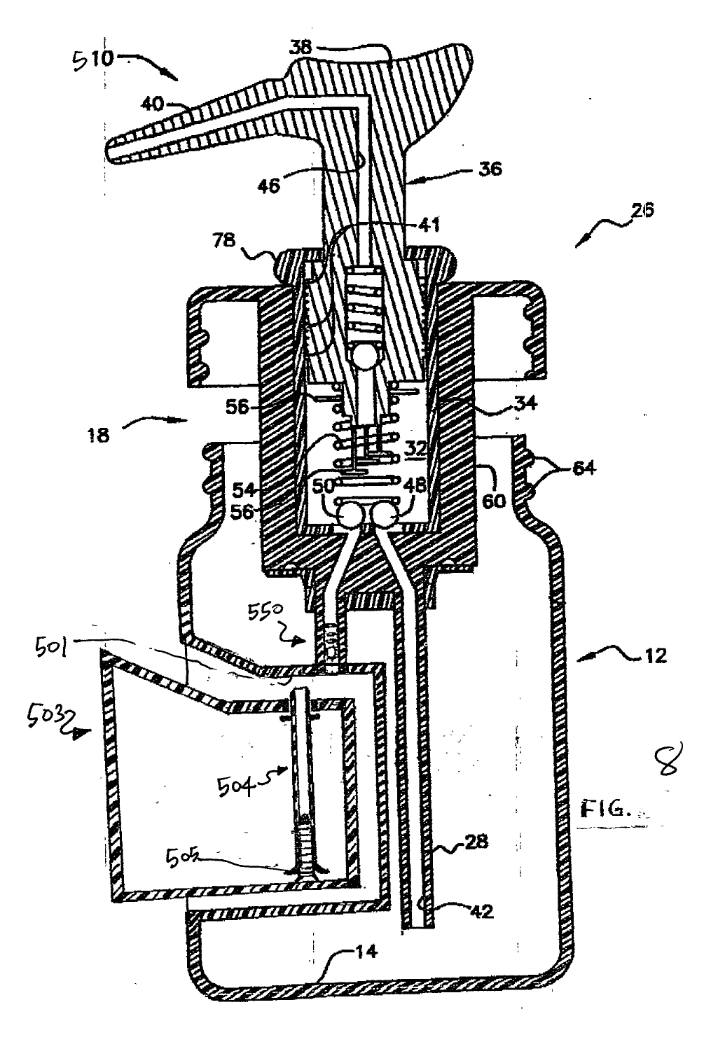

FIG. 8 shows a modification of the embodiment of FIG. 7 wherein the opening of the auxiliary vessel is located at the top of the auxiliary vessel, rather than at the bottom thereof, as shown in the embodiment of FIG. 7. In the embodiment of FIG. 8, a check valve 550 is formed at the top of recess 501. Auxiliary vessel 503 has a valve 504 biased by a spring 505 into the closed position. The upper surface of recess 501 is so configured that valve 504 is depressed when vessel 503 is inserted into recess 501.

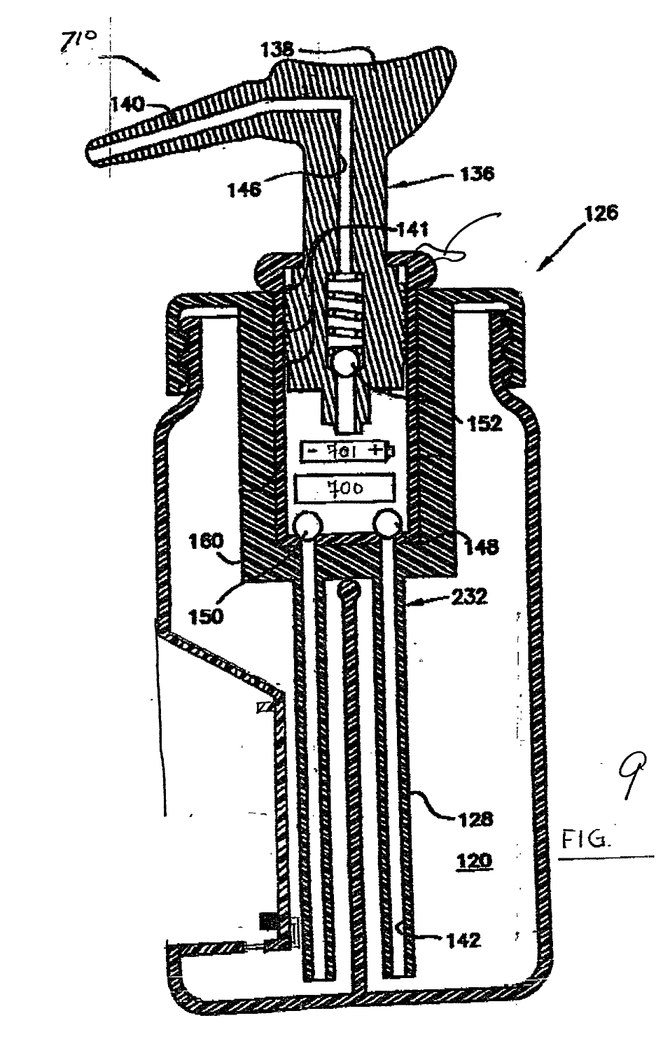

FIG. 9 shows an embodiment of the invention incorporating an electrically operated pump 700 which replaces the plunger operated pump of the previous embodiments. A battery 701 supplies power to pump 700. A switch 702 disposed on the exterior of dispensing container 710 controls pump 700.

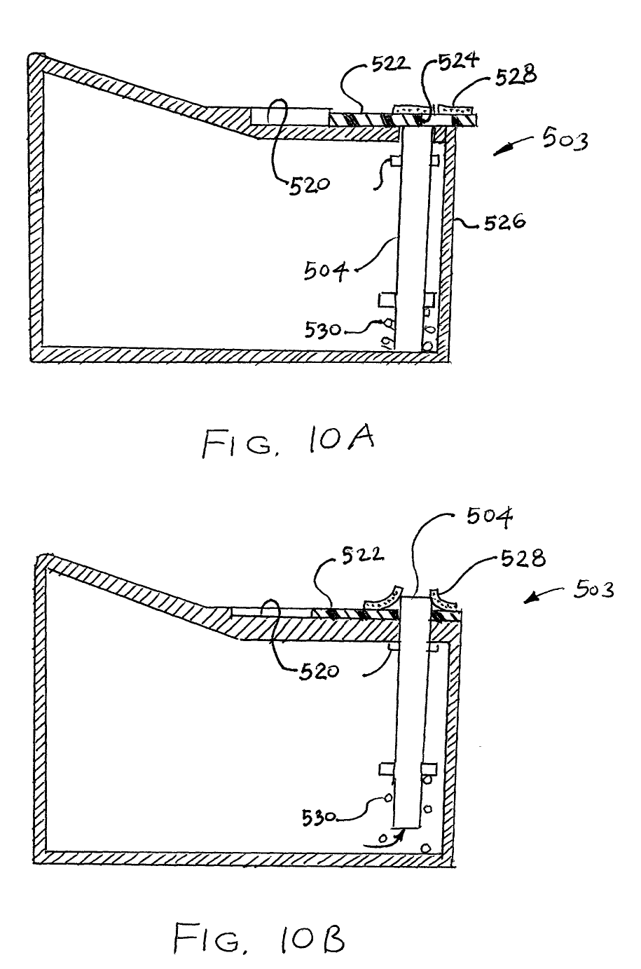

FIG. 10A shows how a seal is provided for those embodiments utilizing the arrangement of valve 504 of FIG. 8. Auxiliary vessel 503 has a groove 520 which slidingly retains a tab 522 having an opening 524 and a flexible membrane 528. Tab 522 projects beyond lateral side 526 of vessel 503. When vessel 503 is inserted into its host container 510 (see FIG. 8), tab 522 is displaced to the left, as depicted in FIG. 10A. The displaced condition is shown in FIG. 10B. Valve 504 aligns with opening 524 and is urged by spring 530 to project upwardly therethrough. Upward travel of valve 504 is limited by stop 532. Fluid contained within vessel 503 can now escape through valve 504, which is a hollow tube, Valve 504 is aligned with the passageway associated with check valve 550 (see FIG. 8). The contents of vessel 503 thereby establish fluid communication with chamber 32 of the pump.

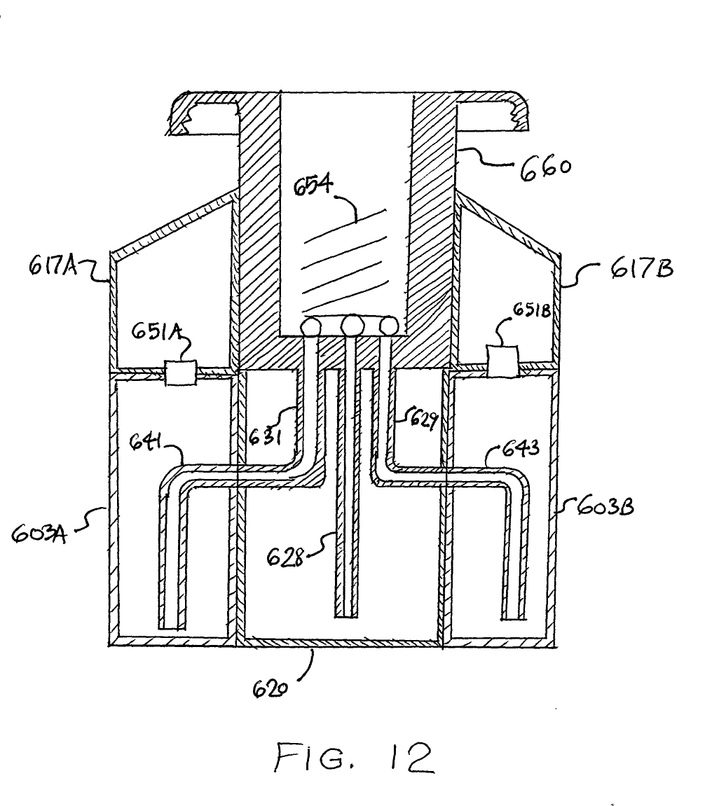

If desired, direction of discharge of the contents of the auxiliary vessel may be at the bottom thereof. This embodiment is shown in FIG. 11, wherein vessel 803 is generally equivalent to vessel 503 of FIG. 10A.

As described with reference to FIG. 12, plural attachable auxiliary vessels may be employed with one dispensing container. With only the portion 660 shown, the portion 660 corresponding to portion 60 of FIG. 1, it being understood that portion 60 is a part of a dispensing container (not shown in its entirety) generally similar to that of FIG. 1, three pick up tubes 628, 629, 631 project downwardly. Tube 628 communicates with receptacle 620, which is either integrally formed with the associated dispenser container or alternatively as a detachable part thereof. Tubes 629, 631 respectively communicate with separate auxiliary vessels 603P, 603B. Each vessel 603A, 603B removably connects to receptacle 620, and communicates therewith by a respective pick up tube extension 641, 643. Fluids contained within vessels 603A, 603B, and receptacle 620 are drawn into the pump simultaneously when the pump operates.

Auxiliary vessels 603A, 603B are replenished by respective removably attachable auxiliary vessels 617A, 617B. Vessels 603A and 617A mutually attach by snap structures (not; shown) or in any other suitable way. Valves 651A, 651B control transfer of fluid into vessels 603A, 603B. Valves 651A, 651B may take the form of manual valve 304 (see FIG. 7A) or interference operated valve 308 (see FIG. 7A).

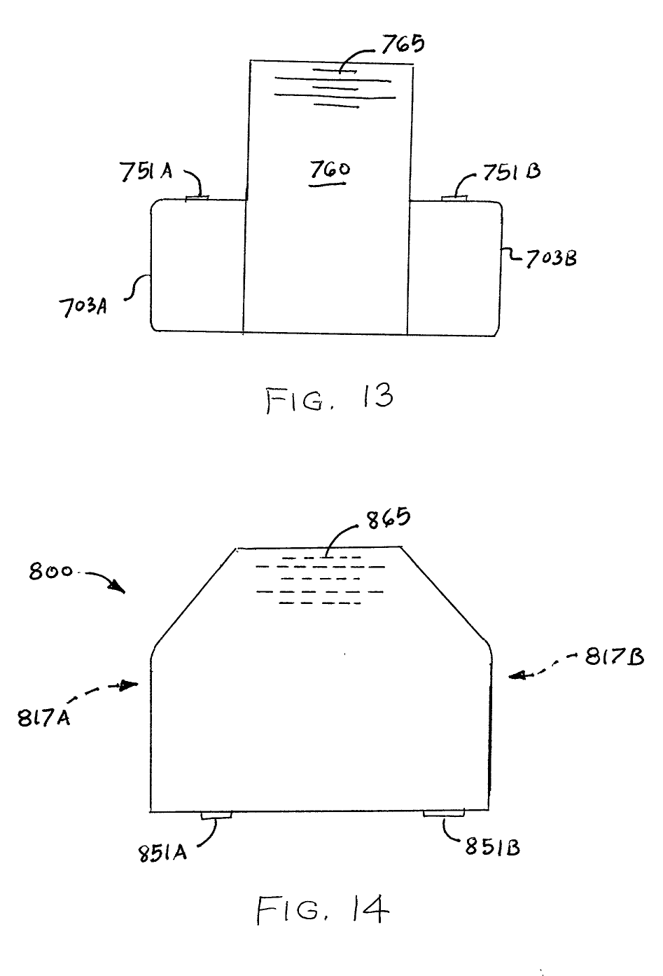

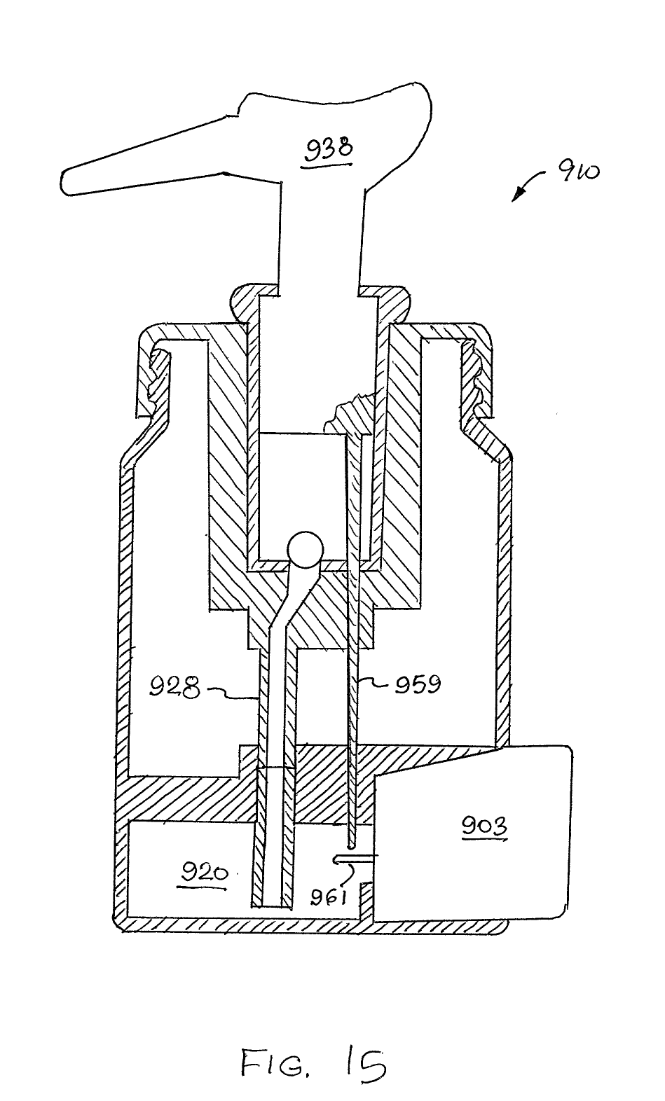

FIG. 13 shows a variation of the embodiment of FIG. 12, wherein receptacle 760 has external threads 765 for connection enabling mounting of auxiliary vessels 817A, 817B (see FIG. 14). Auxiliary vessels 703A, 703B are shown connected to receptacle 760. Internal fluid communication among receptacle 760 and auxiliary vessels 703A, 703B is accomplished as discussed relative to other embodiments. Valves 751A, 751B are shown as part of associated vessels 703A, 703B, respectively. A unitary assembly uniting auxiliary vessels 817A, 817B is shown in FIG. 14, wherein a skirt 800 envelops vessels 817A, 817B. Skirt 800 has internal threads 865 which mate with threads 765 of receptacle 760. Valve connectors 851A, 851B enable communication between each upper and lower pair of auxiliary vessels 703A, 817A or 703B, 817B.

FIG. 15 shows a mechanical interlocking feature optionally and preferably utilized with those embodiments of the invention wherein the auxiliary vessel contains a propellant gas under pressure. In the embodiment of FIG. 15, container 910 is generally structurally similar to any of the prior embodiments of the invention, but has an interlock feature which assures that pressurized propellant gas is released into container 910 from auxiliary vessel 903 only when the user is dispensing liquids contained within container 910.

When head 938 is depressed, an arm 959 comes into contact with lever 961 of a tilt switch (not shown in its entirety) of auxiliary vessel 903. The tilt switch may be generally conventional, being that type which opens when lever 961 is tilted from the horizontal orientation shown in FIG. 15. Propellant gas contained at pressures above ambient pressures within auxiliary vessel 903 enters chamber 920, thereby propelling liquids (not shown) contained within chamber 920 into pick up tube 928 for ultimate ejection through head 938 in a manner similar to that of the other embodiments.

Releasing head 938 so that head 938 returns to the original position shown in FIG. 15 will release lever 961 to reassume its original position, thereby closing its associated tilt valve. This feature avoids unduly depleting auxiliary vessel 903 but more importantly spares container 910 from being subjected to injurious high pressures. Therefore, container 910 is fabricated inexpensively from materials such as plastics, whereas only auxiliary vessel 903 need be fabricated to standards appropriate for containing high pressures typical of gas propellants. Illustratively, auxiliary vessel 903 is fabricated selectively from metals and metal alloys, such as, for example, steel and aluminum.

The present invention is susceptible to variations and modifications which may be introduced thereto without departing from the inventive concept. For example, valves disposed upon the auxiliary vessel, and structure located on the dispensing container for opening the valves by interference may be reversed in their locations. Also, valves shown and described herein may be replaced by other types of valves. For example, valves actuated by insertion of auxiliary vessels into the host container could be tilt-lever valves (not shown), wherein a horizontal projection contacts a pivotal arm. When the arm is contacted, it pivots and opens the valve. Check valves may take the form of solid members or flaccid membranes which yieldably cover ports formed in solid walls of the container and its associated auxiliary vessels. In a further example, any of the novel improvements shown herein may be utilized with any of the embodiments of the dispensing containers described herein.

Additional features may be incorporated into any of the embodiments of the invention. For example, a pressure relieiE feature may be incorporated into those containers which operate by pressure. In a second example, a mechanical interlock, such as link 307 of FIGS. 7A-7C, may be employed to vent pressure which would otherwise be unrelieved in various chambers and conduits of the novel container. This is accomplished by providing selectively overlapping contact of an auxiliary vessel with the link or other actuators of valves. The venting valve would be held open until after the fluid control valve closes. Thus pressure is vented after the source of pressure is closed.

It is to be understood that the present invention is not limited to the embodiments described above, but encompasses any and all embodiments within the scope of the following claims.

I claim:

1. A dispensing container for storing fluids separately and blending and dispensing these fluids, comprising:
a storage bottle having a floor, a lateral wall, an open upper end, and a first receptacle, said lateral wall having a recess therein;
an auxiliary vessel dimensioned and configured to cooperate with and be insertable into and retained within said recess of said storage bottle; and
a cap closingly engageable with said upper end of said storage bottle, said cap having a mixing and dispensing circuit including
a pick up conduit communicating with said first receptacle of said storage bottle,
a mixing chamber disposed in fluid communication with said pick up conduit,
a pump disposed to pressurize and propel fluids contained within said mixing chamber,
a discharge nozzle opening to the outside atmosphere, and
a discharge conduit disposed to conduct pressurized fluid from said pump to said discharge nozzle,
wherein said lateral wall of said storage bottle has an inlet port communicating between said recess and said mixing and dispensing circuit, and said auxiliary vessel has a valve disposed to communicate with said inlet port and means to open said valve responsive to insertion of said auxiliary vessel into said recess of said storage bottle, whereby fluid contained within said auxiliary vessel establishes communication with said mixing and dispensing circuit.

2. The dispensing container according to claim 1, wherein said dispensing container has a unidirectional check valve closing said inlet port against escape of fluids from said first receptacle.

3. The dispensing container according to claim 1, wherein said first receptacle has a second unidirectional check valve disposed to admit air from the exterior of said dispensing container into said first receptacle responsive to pressures prevailing within said first receptacle lower than ambient pressures.

4. The dispensing container according to claim 1, wherein said valve of said auxiliary vessel opens at the top of said auxiliary vessel.

5. The dispensing container according to claim 1, wherein said valve of said auxiliary vessel opens at the bottom of said auxiliary vessel.

6. The dispensing container according to claim 1, wherein said pump is an electric pump, and said container houses a battery disposed to provide power to said electric pump.

7. The dispensing container according to claim 1, wherein said auxiliary vessel is fabricated selectively from metals and their alloys, and wherein said storage bottle and said cap are fabricated from a plastic material.

8. The dispensing container according to claim 7, wherein said auxiliary vessel is filled with a propellant gas at a pressure above ambient pressure.

9. The dispensing container according to claim 8, further comprising means for releasing pressurized propellant gas into said container only when dispensing liquids contained within said container.

10. A dispensing container for storing fluids separately and blending and dispensing these fluids, comprising:
a storage bottle having a floor, a lateral wall having a recess formed therein, and a first receptacle;
at least one auxiliary vessel dimensioned and configured to cooperate with and be insertable into and retained within said recess of said storage bottle; and
a mixing and dispensing circuit including
a pick up conduit communicating with said first receptacle,
a mixing chamber disposed in fluid communication with said pick up conduit,
a pump disposed to pressurize and propel fluids contained within said mixing chamber, and
a discharge conduit disposed to conduct pressurized fluids away from said pump, wherein
said lateral wall of said storage bottle has an inlet port communicating between said recess and said mixing and dispensing circuit, and said auxiliary vessel has a valve disposed to communicate with said inlet port and to be opened when said auxiliary vessel is inserted into said recess of said storage bottle, whereby fluid contained within said auxiliary vessel establishes communication with said mixing and dispensing circuit.

11. The dispensing container according to claim 10, wherein said at least one auxiliary vessel comprises a plurality of auxiliary vessels, and said dispensing container includes means for establishing fluid communication among said storage bottle and said auxiliary vessels.

12. The dispensing container according to claim 10, wherein said storage bottle has a plurality of compartments and means for establishing fluid communication between each said compartment and said pump.

13. The dispensing container according to claim 12, wherein said at least one auxiliary vessel comprises an additional auxiliary vessel and means for establishing fluid communication between said additional auxiliary vessel and said at least one auxiliary vessel.

14. The dispensing container according to claim 11, wherein said at least one auxiliary vessel comprises a plurality of first auxiliary vessels, a plurality of second auxiliary vessels, and means for establishing fluid communication between each one of said first auxiliary vessels and an associated one of said second auxiliary vessels.

15. The dispensing container according to claim 14, wherein said storage bottle of said dispensing container includes a cap closingly engageable with said storage bottle, wherein said pump is fixed to said cap, and has a discharge nozzle disposed in fluid communication with said discharge conduit.

16. The dispensing container according to claim 10, wherein said valve of said auxiliary vessel is manually operated.

17. The dispensing container according to claim 10, further including means for opening said valve of said auxiliary vessel by interfering contact with said storage bottle.

18. The dispensing container according to claim 10, wherein said auxiliary vessel is fabricated selectively from metals and their alloys, and wherein-said storage bottle is fabricated from a plastic material.

19. The dispensing container according to claim 10, wherein said auxiliary vessel is filled with a propellant gas at a pressure above ambient pressure.

20. The dispensing container according to claim 19, further comprising means for releasing pressurized propellant gas into said container only when dispensing liquids contained within said container.
